(19) United States
(12) Patent Application Publication
(10) Pub. No.: US 2018/0292031 A1
(43) Pub. Date: Oct. 11, 2018

(54) Heat Shrink Tubing

(71) Applicant: Heat Shrink Innovations, LLC, Carrolton, TX (US)

(72) Inventors: Kevin Wolfe, Carrollton, TX (US); Deborah Wolfe, Carrollton, TX (US); Terry Upchurch, Carrollton, TX (US); Lana Upchurch, Carrollton, TX (US)

(73) Assignee: Heat Shrink Innovations, LLC, Carrollton, TX (US)

(21) Appl. No.: 15/482,381

(22) Filed: Apr. 7, 2017

(51) Int. Cl. F16L 11/12; B29C 47/00; B29C 63/00; B29C 63/18; F16L 11/04

(52) U.S. Cl. CPC F16L 11/12; B29C 47/0023; B29C 47/0064; B29K 2027/18; B29C 63/18; B29C 47/0004; F16L 11/04; B29C 63/0069

(57) ABSTRACT

An embodiment of heat-shrinkable tubing capable of providing the strength characteristics of known heat-shrinkable tubing embodiments while maintaining a low peel force for easy removal from a shaft or other solid body during extrusion and expansion manufacturing.

### CROSS-REFERENCE TO RELATED APPLICATIONS

This application claims the benefit of provisional patent application Ser. No. 62/320,242, filed on Apr. 8, 2016.

### TECHNICAL FIELD

The present invention relates to thermoplastic tubing; and, more particularly, heat-shrinkable tubing.

### BACKGROUND

The following is a tabulation of potentially relevant patents, applications, or non-patent publications:

| patent No. | Issue Date | Patentee |
|---|---|---|
| U.S. Pat. No. 9,440,044 B2 | Sep. 13, 2016 | Roof |
| U.S. Pat. No. 9,446,171 | Sep. 20, 2016 | Suzuki |
| U.S. Pat. No. 4,029,868 | Jun. 14, 1977 | Carlson |
| U.S. Pat. No. 4,411,654 | Oct. 25, 1983 | Boarini |
| U.S. Pat. No. 7,736,571 | Jun. 15, 2010 | Trapp |

| Patent Application | Publication Date | Applicant |
|---|---|---|
| U.S. 2010/0268196 | Oct. 21, 2010 | Hastings |

Thermoplastics and heat-shrinkable tubing have long existed in the modern world, with uses as varied from mere aesthetics to practical electrical and medical applications. Of the many practical uses, one of the most important applications is the catheter manufacturing process. Due to the fragility of catheters, catheter fabrication is a highly tedious process with little margin for error. Thermoplastics advantageously allow for the bundling of small components and devices into a single, wrapped package. As such, heat-shrinkable tubing helps streamline the catheter fabrication process by thermodynamically combining and sealing the separate components of the catheter tubing.

However, the primary issue with utilizing heat-shrinkable tubing in the manufacturing of catheters is the need for removal of the heat-shrunk tubing from the catheter once the process is complete. Known heat-shrinkable tubing embodiments which feature such peelable characteristics generally require perforating, cutting, or scoring of the heat-shrunk tubing to remove the tubing from around the catheter shaft or other solid body. Generally, such cutting, scoring, or perforating requires a perforation or scoring line which traverses the length of the tubing. Known heat-shrinkable tubing with peelable characteristics generally feature either a pre-cut slit on at least one end of the tubing or come with a slit-cutting tool whereby the manufacturer recommends a slit be cut prior to peeling the tubing in the longitudinal direction (e.g., U.S. Pat. No. 9,440,044 and U.S. Pat. No. 9,446,171). However, due to the fragility of catheters, even the slightest error in cutting or scoring could damage and ruin the catheter. Accordingly, known heat-shrinkable tubing embodiments are substantially limited in the removal, or “peelability,” of the tubing from the catheter due to the necessity to make slit in the tubing.

### SUMMARY OF THE INVENTION

In accordance with the invention, the catheter manufacturing process may be greatly streamlined through the utilization of an easily-removable, heat-shrinkable tubing capable of removal from a catheter without the need for cutting, scoring, or perforations. Such a tubing would greatly facilitate control over the catheter manufacturing process, yielding much less waste and much greater manufacturing quality standards.

Streamlined removal of the heat-shrunk tubing can be achieved through a fluoropolymer heat-shrinkable tubing which can be easily peeled back and removed without the necessity of cutting, scoring, or perforating the heat-shrunk tubing. The tubing may be comprised from any desired material. In particular embodiments of the invention, the heat-shrinkable tubing may provide such consistent and uniform peeling capabilities so the tubing may be peeled back and removed by either a human or robotic operator.

Such tubing may also feature a smooth, glass-like finish or a more opaque finish, depending on the desires of a user. The tubing may be made from any desired material that allows for the controlled longitudinal growth, desired shrink ratios, and desired clarity or opaqueness. Accordingly, the peelable, heat-shrinkable tubing may be configured to provide customized shrink ratios for various applications. If desired, the peelable, heat-shrinkable tubing may be constructed with various wall thickness and clarity for various other applications in extrusion and expansion manufacturing processes.

### BRIEF DESCRIPTION OF THE DRAWINGS

FIG. 1 depicts a heat-shrinkable tubing embodying the principles of the present invention;

FIG. 2 depicts a semi-peeled heat-shrinkable tubing embodying the principles of the present invention.

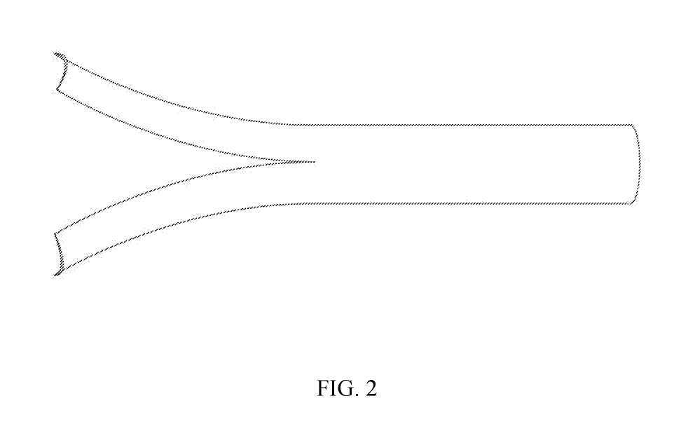

### DETAILED DESCRIPTION OF THE DRAWINGS

As noted above, known heat-shrinkable tubing embodiments and materials generally require perforating, cutting, or scoring of the heat-shrunk tubing to remove the tubing from around the catheter shaft or solid body. Accordingly, this substantially limits the practical uses of known heat-shrinkable tubing embodiments and materials.

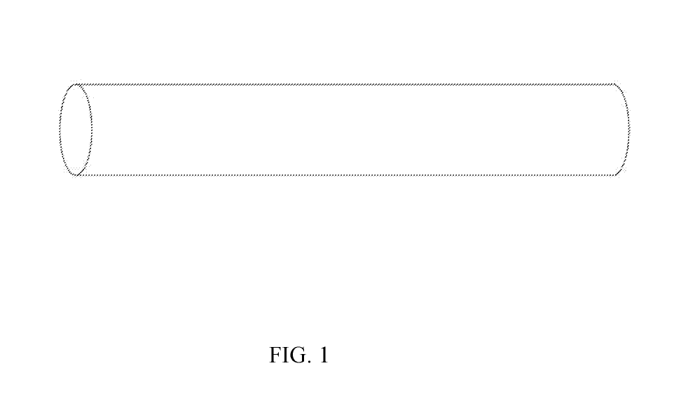

FIG. 1 depicts the differences between the known heat-shrinkable tubing embodiments and a peelable, heat-shrinkable tubing embodying the principles of the present invention. As shown in FIG. 1, a Fluorinated Ethylene Propylene (“FEP”) heat-shrinkable tubing is one of the most commonly-used materials for heat-shrinkable tubing. Although FEP heat-shrinkable tubing provides exceptional quality and control throughout the heat-shrinking phase, FEP heat-shrinkable tubing must be cut, scored, or perforated in order to remove the tubing from the catheter shaft during catheter fabrication. Due to the fragility of a catheter, any cutting or scoring during removal of the heat-shrunk tubing may yield catastrophic results to catheter fabrication.

Accordingly, a peelable, heat-shrinkable tubing embodying the principles of the present invention would be widely desired and utilized to negate the issues with known heat-shrinkable tubing embodiments. In a particular embodiment, a peelable, heat-shrinkable tubing comprised of a mixture of FEP and Ethylene Tetrafluoroethylene (“ETFE”) would produce a heat-shrinkable tubing with a low peel force to facilitate the desired easy removal of the tubing from a catheter or other shaft in extrusion and expansion manufacturing.

The foregoing merely illustrates the principles of the present invention. Therefore, it will be appreciated that those skilled in the art will be able to devise numerous alternative arrangements that, while not shown or described herein, embody the principles of the present invention and thus are within the spirit and scope of the invention.

What is claimed is:

1. A peelable, heat-shrinkable tubing adapted to peel easily without the necessity of a perforation, cut, or score, comprised of:
at least one fluorinated ethylene propylene resin; and
at least one ethylene tetrafluoroethylene resin.

2. The peelable, heat-shrinkable tubing of claim 1, wherein said tubing features a peripheral wall selected from the group consisting of: a transparent wall, a translucent wall, and an opaque wall.

3. The peelable, heat-shrinkable tubing of claim 2, wherein said tubing may be customizably shrunk to a desired diameter smaller than the original diameter of said tubing.

4. The peelable, heat-shrinkable tubing of claim 3, wherein said tubing may exhibit elemental exposure resistance selected from the group consisting of: chemical resistance, water resistance, and ultraviolet resistance.

5. The peelable, heat-shrinkable tubing of claim 4, wherein said tubing exhibits a longitudinal shrinkage of 5% or less of a starting length of said tubing.

6. The peelable, heat-shrinkable tubing of claim 5, wherein said tubing exhibits a concentricity of at least 90%.

7. The peelable, heat-shrinkable tubing of claim 6, wherein said tubing is comprised of at least one or more additional thermoplastic resins.

8. A method of preparing and utilizing peelable, heat-shrinkable tubing, comprising:
Mixing two or more thermoplastic resins into a thermoplastic resin mixture;
Extruding said resin mixture into a tubing, wherein said tubing exhibits an initial inner diameter, wall thickness, and length;
Inserting components into said tubing;
Exposing said tubing to a desired temperature;
Shrinking said tubing to adhere to said components, wherein said tubing exhibits longitudinal shrinkage of 5% or less of said initial length; and
Peeling said tubing from said components without any perforations, scoring, or cutting.
